(19) United States
(12) Patent Application Publication
(10) Pub. No.: US 2026/0153134 A1
(43) Pub. Date: Jun. 4, 2026

(54) BRAKE ROTOR WITH A MULTIFUNCTIONAL COATING

(71) Applicant: GM Global Technology Operations LLC, Detroit, MI (US)

(72) Inventors: Zhongyi Liu, Troy, MI (US); Heewook Lee, Oakland Township, MI (US); Ratandeep Singh Kukreja, Auburn Hills, MI (US); Jiachen Pang, Shanghai (CN); Jianfeng Wang, Shanghai (CN)

(21) Appl. No.: 18/968,161

(22) Filed: Dec. 4, 2024

(30) Foreign Application Priority Data
Dec. 2, 2024 (CN) 202411754785.1

(51) Int. Cl. F16D 65/12; F16D 65/02; F16D 69/02

(52) U.S. Cl. CPC F16D 65/127; F16D 65/125; F16D 69/027; F16D 2065/132; F16D 2200/0021; F16D 2200/003; F16D 2200/0039; F16D 2200/0078; F16D 2250/0046

(57) ABSTRACT

A brake rotor having a multifunctional coating and method is provided. The brake rotor includes an annular body further having a core formed of an aluminum-silicon (Al—Si) alloy and including at least one annular disc having an annular surface and a multilayer coating disposed on at least a portion of the core. The multilayer coating includes a metal bonding layer disposed on the annular surface, a heat resistant layer disposed on the metal bonding layer, and a wear resistant layer disposed on the heat resistant layer. The metal bonding layer includes at least one of Nickel-Cobalt-Chromium-Aluminum-Yttrium (NiCoCrAlY) or Nickel-Chromium-Aluminum (NiCrAl). The heat resistant layer includes yttria-stabilized zirconia (YSZ) and ceria-stabilized zirconia (CSZ). The wear resistant layer includes stainless steel and carbide feedstock.

### INTRODUCTION

The present disclosure relates to a brake rotor, and more particularly, to a brake rotor formed of an aluminum silicon alloy and having a multifunctional coating.

Disc brake assemblies of automotive vehicles include a disc or rotor with a pair of annular friction surfaces on opposite sides thereof. The rotor may be mounted on a rotatable axle of the vehicle, which may be coupled to a wheel of the vehicle. During braking, an outer periphery of the rotor is clamped between a pair of opposing brake pads, which engage the friction surfaces of the rotor and slow or stop rotation of the rotor and the wheel. Brake rotors of automotive vehicles are oftentimes made of cast iron, which can withstand the high friction forces and high temperatures generated during braking. However, cast iron may be heavy and prone to corrosion. Cast iron may also increase particle emission.

While present iron-based brake rotors may achieve their intended purpose, there is a need for lighter-weight brake motors that withstand elevated operating temperatures and decrease vehicle weight.

### SUMMARY

According to several aspects of the present disclosure, a brake rotor having a multifunctional coating is provided. The brake rotor includes an annular body defining opposite friction surfaces. The annular body includes a core formed of an aluminum-silicon (Al—Si) alloy and including at least one annular disc having an annular surface and a multilayer coating disposed on at least a portion of the core. The multilayer coating is configured to provide wear resistance and increase operating temperature. The multilayer coating includes a metal bonding layer disposed on the annular surface, a heat resistant layer disposed on the metal bonding layer, and a wear resistant layer disposed on the heat resistant layer. The metal bonding layer includes at least one of Nickel-Cobalt-Chromium-Aluminum-Yttrium (NiCoCrAlY) or Nickel-Chromium-Aluminum (NiCrAl). The heat resistant layer includes yttria-stabilized zirconia (YSZ) and ceria-stabilized zirconia (CSZ). The wear resistant layer includes stainless steel and carbide feedstock.

In accordance with another aspect of the disclosure, the metal bonding layer has a thickness between about 10-100 microns (μm).

In accordance with another aspect of the disclosure, the metal bonding layer includes between about 55-65% nickel (Ni), between about 10-30% cobalt (Co), between about 10-20% chromium (Cr), between about 5-10% aluminum (Al), and between about 0.1-0.5% yttrium (Y).

In accordance with another aspect of the disclosure, the metal bonding layer includes a Nickel-Chromium-Aluminum (NiCrAl) alloy having between about 30-45% chromium (Cr), between about 2-6% aluminum (Al), and a balance being nickel (Ni).

In accordance with another aspect of the disclosure, the heat resistant layer includes about 75% yttria-stabilized zirconia (YSZ) and about 25% ceria-stabilized zirconia (CSZ).

In accordance with another aspect of the disclosure, the yttria-stabilized zirconia (YSZ) includes ZrO₂ stabilized with between about 5-10% Y₂O₃.

In accordance with another aspect of the disclosure, the ceria-stabilized zirconia (CSZ) includes ZrO₂ stabilized with between about 5-10% CeO₂.

In accordance with another aspect of the disclosure, the heat resistant layer has a thickness between about 50 and 200 micrometers (μm).

In accordance with another aspect of the disclosure, the heat resistant layer has a thermal conductivity between about 0.4 to 1.5 watts per meter-kelvin (W/m·K).

In accordance with another aspect of the disclosure, the wear resistant layer has a thickness between about 100 and 300 micrometers (μm).

In accordance with another aspect of the disclosure, the stainless steel includes at least one of 430L steel, 316L steel, or 318LN steel.

In accordance with another aspect of the disclosure, the carbide feedstock includes at least one of tungsten carbide (WC), titanium carbide (TiC), chromium carbide (Cr3C2), or niobium carbide (NbC).

In accordance with another aspect of the disclosure, the wear resistant layer has a thermal conductivity of between about 18 to 50 watts per meter-kelvin (W/m·K).

In accordance with another aspect of the disclosure, the wear resistant layer has a Vickers hardness number between about 400-700 (HV).

According to several aspects of the present disclosure, a brake rotor having a multifunctional coating is provided. The brake rotor includes an annular body defining first and second friction surfaces. The annular body includes a core formed of an aluminum-silicon (Al—Si) alloy and including a first and second annular disc spaced apart from each other in an axial direction by a plurality of ribs. Each of the first and second annular discs respectively have a first and second annular surface. The annular body also includes a first and second multilayer coating disposed respectively on the first and second annular surface. The first and second multilayer coatings are configured to provide wear resistance and increase operating temperature. The first and second multilayer coatings include first and second metal bonding layers respectively disposed on the first and second annular surfaces, first and second heat resistant layers respectively disposed on the first and second metal bonding layers, and first and second wear resistant layers respectively disposed on the first and second heat resistant layers. The first and second metal bonding layers include at least one of Nickel-Cobalt-Chromium-Aluminum-Yttrium (NiCoCrAlY) or Nickel-Chromium-Aluminum (NiCrAl). The first and second heat resistant layers include yttria-stabilized zirconia (YSZ) and ceria-stabilized zirconia (CSZ). The first and second wear resistant layers include stainless steel and carbide feedstock, and the first and second wear resistant layers respectively define the first and second friction surfaces of the annular body

In accordance with another aspect of the disclosure, the first and second metal bonding layers include at least one of Nickel-Cobalt-Chromium-Aluminum-Yttrium (NiCoCrAlY) or Nickel-Chromium-Aluminum (NiCrAl).

In accordance with another aspect of the disclosure, the first and second heat resistant layers include yttria-stabilized zirconia (YSZ) and ceria-stabilized zirconia (CSZ).

In accordance with another aspect of the disclosure, the first and second wear resistant layers include stainless steel and carbide feedstock.

According to several aspects of the present disclosure, a method for manufacturing a brake rotor is provided. The method includes casting an Al—Si alloy into a shape of a rotor core including at least one annular disc having an annular surface, identifying a thickness-dependent heat and temperature distribution for the annular surface, determining a multilayer coating for the annular surface of the brake rotor based on the thickness-dependent heat and temperature distribution, and depositing the multilayer coating on the annular surface of the brake rotor using a directed energy deposition (DED) process to form a wear-resistant layer. The multilayer coating includes a metal bonding layer disposed on the annular surface, a heat resistant layer disposed on the metal bonding layer, and a wear resistant layer disposed on the heat resistant layer.

In accordance with another aspect of the disclosure, the metal bonding layer includes at least one of Nickel-Cobalt-Chromium-Aluminum-Yttrium (NiCoCrAlY) or Nickel-Chromium-Aluminum (NiCrAl), the heat resistant layer includes yttria-stabilized zirconia (YSZ) and ceria-stabilized zirconia (CSZ), and the wear resistant layer includes stainless steel and carbide feedstock.

The above features and advantages, and other features and advantages, of the presently disclosed system and method are readily apparent from the detailed description, including the claims, and examples when taken in connection with the accompanying drawings.

### BRIEF DESCRIPTION OF THE DRAWINGS

The present disclosure will become more fully understood from the detailed description and the accompanying drawings, wherein:

FIG. 1 is a perspective view illustrating a brake rotor for a disc brake assembly of a motor vehicle, where the brake rotor includes a hub and an annular body, in accordance with the present disclosure.

FIG. 2 is a cross section schematic view of the annular body shown in FIG. 1 taken along line 2-2 of FIG. 1, where the annular body includes a core and a multilayer coating disposed on at least a portion of the core, in accordance with the present disclosure.

FIG. 3 is a flowchart illustrating a method for manufacturing the brake rotor as shown in FIGS. 1 and 2, in accordance with the present disclosure.

FIG. 4 is a schematic cross section view of an apparatus for depositing the multilayer coating on a portion of the core of the annular hub illustrated in FIGS. 1 and 2, in accordance with the present disclosure.

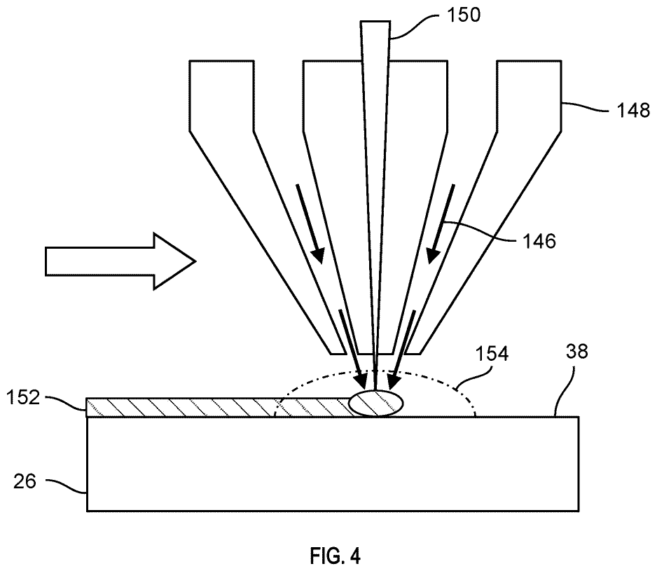

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale. The following description is merely exemplary in nature and is not intended to limit the present disclosure, application, or uses.

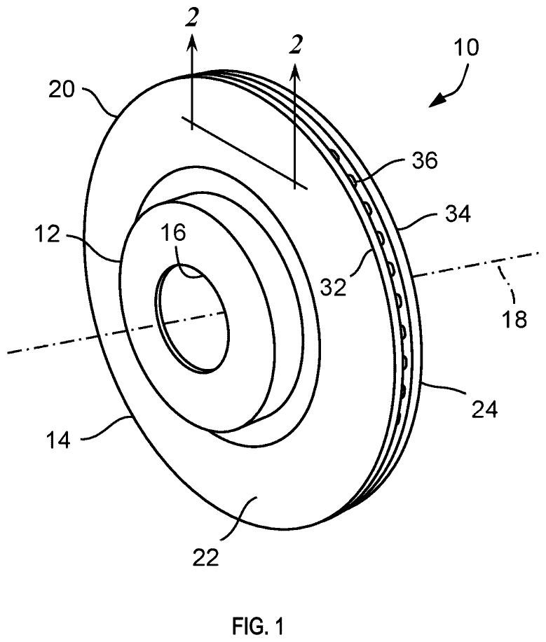

FIG. 1 depicts a brake rotor 10 for a disc brake assembly of a motor vehicle (not shown) having a multifunctional or multilayer coating 11. The brake rotor 10 includes a hub 12, an annular body 14, and a central opening 16 that defines an axis of rotation 18 of the brake rotor 10. The hub 12 may be configured to mount the brake rotor 10 to a rotatable axle (not shown) of the motor vehicle. The annular body 14 extends in a radial direction from the central opening 16 and defines an outer periphery 20 of the brake rotor 10 and first and second friction surfaces 22, 24 disposed on opposite sides of the brake rotor 10. The first and second friction surfaces 22, 24 are configured to engage with brake pads (not shown) disposed on opposite sides of the brake rotor 10 to generate frictional forces that oppose rotation of the brake rotor 10 during braking.

The presently disclosed brake rotor 10 may exhibit other configurations, as will be appreciated by a person of ordinary skill in the art. For example, and in some instances, the hub 12 may be omitted and the brake rotor 10 may be coupled to a rotatable axle of a motor vehicle by other means.

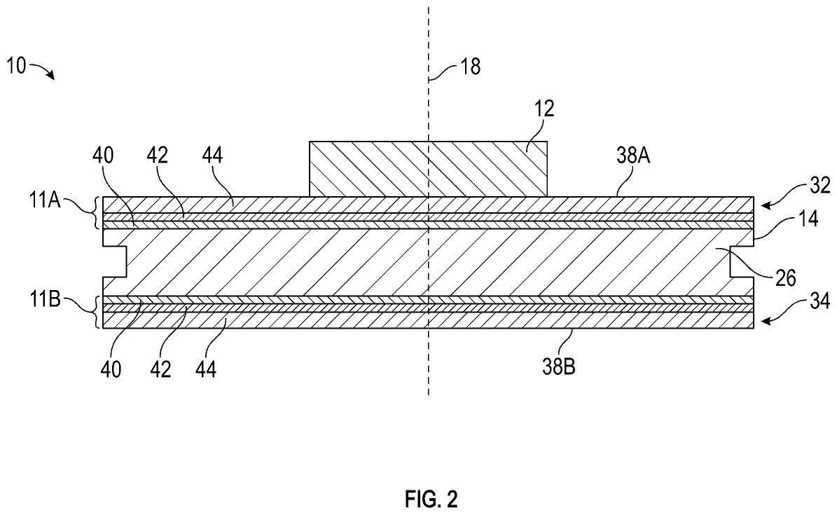

Referring now to FIGS. 1 and 2, where FIG. 2 is a cross section schematic view of the annular body shown in FIG. 1 taken along line 2-2, the annular body 14 has a composite structure including a core 26 and a multilayer coating 11 disposed on at least a portion of the core 26. The core 26 includes at least one annular disc 32, 34 that defines a pair of annular surfaces 38A, 38B disposed on opposite sides of the brake rotor 10 and facing away from the core 26. The core 26 depicted in FIGS. 1 and 2 includes a pair of first and second annular discs 32, 34 disposed on opposite sides of the brake rotor 10 and spaced apart from each other in an axial direction by a plurality of ribs 36. Each of the first and second annular discs 32, 34 respectively has an annular surface (e.g., first annular surface 38A, a second annular surface 38B) that faces away from the core 26. The core 26 may have a thickness, measured between the opposite annular surfaces 38A, 38B of greater than or equal to about 9 millimeters to less than or equal to about 36 millimeters. The core 26 may be of unitary one-piece construction.

The core 26 is made of a hypereutectic aluminum (Al) alloy comprising, in addition to aluminum, at least one alloying element including silicon (Si), and thus may be referred to as an aluminum silicon (Al—Si) alloy. The amount of silicon in the Al—Si alloy is selected to provide the Al—Si alloy with good castability, fluidity, and wear-resistance. The Al—Si alloy may comprise, by mass, greater than or equal to about 80% to less than or equal to about 87% aluminum and greater than or equal to about 13% to less than or equal to about 20% silicon. In this context, the term “about” will be understood to one of skill in the art. Alternatively, the term “about” is understood to mean plus or minus 1%.

In some instances, the Al—Si alloy may include carbon (C) as an alloying element. In these instances, the Al—Si alloy may include, by mass, greater than or equal to about 4% to less than or equal to about 8% carbon. The carbon may be present in the Al—Si alloy in the form of silicon carbide (SiC). In such case, the Al—Si alloy may include, by mass, greater than or equal to about 10% to less than or equal to about 20% silicon carbide. In this context, the term “about” will be understood to one of skill in the art. Alternatively, the term “about” is understood to mean plus or minus 1%.

In some instances, the Al—Si alloy may include titanium boride (TiB₂) to provide higher strength, hardness, wear resistance and higher thermal stability. In these instances, the Al—Si alloy may include, by mass, greater than or equal to about 5% to less than or equal to about 15% titanium boride. In this context, the term “about” will be understood by one of skill in the art. Alternatively, the term “about” is understood to mean plus or minus 1%.

In some instances, the Al—Si alloy may include aluminum oxide (Al₂O₃) to provide higher thermal stability and resistance to corrosion. In these instances, the Al—Si alloy may include, by mass, greater than or equal to about 10% to less than or equal to about 15% aluminum oxide. In this context, the term “about” will be understood by one of skill in the art. Alternatively, the term “about” is understood to mean plus or minus 1%.

In some instances, the Al—Si alloy may include titanium carbide (TiC) or zirconium oxide (ZrO₂) to improve the hardness and thermal shock resistance helps to extend service life under harsh conditions. In these instances, the Al—Si alloy may include, by mass, greater than or equal to about 3% to less than or equal to about 10% titanium carbide; and/or greater than or equal to about 1% to less than or equal to about 10% zirconium oxide. In this context, the term “about” will be understood by one of skill in the art. Alternatively, the term “about” is understood to mean plus or minus 1%.

As compared to cast iron, the Al-Si alloy exhibits excellent corrosion resistance, high ductility, and low density. For example, the Al—Si alloy may have a density of greater than or equal to about 2,600 kilograms per cubic meter (kg/m³) to less than or equal to about 2,800 kg/m³ or less than or equal to about 2,700 kg/m³. In one specific example, the Al—Si alloy may have a density of about 2,700 kg/m³. In this context, the term “about” will be understood to one of skill in the art. Alternatively, the term “about” is understood to mean plus or minus 10 kg/m³. The Al—Si alloy may exhibit a thermal conductivity of greater than or equal to about 186 watts per meter-kelvin (W/m·K) to less than or equal to about 225 W/m·K and a specific heat of greater than or equal to about 0.9 kJ/kg·K to less than or equal to about 1.3 kJ/kg·K. In this context, the term “about” will be understood to one of skill in the art. Alternatively, the term “about” is understood to mean plus or minus 1 W/m·K.

Still referring to FIGS. 1 and 2, the multilayer coating 11 is disposed on at least a portion of the core 26. In the specific example illustrated in FIGS. 1 and 2, the multilayer coating 11 is shown disposed on the first friction surface 22 and the second friction surface 24. However, the multilayer coating 11 may also be disposed on other or additional portions of the core 26, for example the hub 12. The multilayer coating 11 is configured to provide wear resistance and increase operating temperature. A first and second multilayer coating 11A, 11B are disposed respectively on the first and second annular surface 38A, 38B. The multilayer coating 11 includes a metal bonding layer 40, a heat resistant layer 42, and a wear resistant layer 44.

The metal bonding layer 40 is disposed on at least a portion of the core 26 and may include one or more layers (e.g., first and second metal bonding layers). The metal bonding layer 40 is formed of at least one of nickel-cobalt-chromium-aluminum-yttrium (NiCoCrAlY) or Nickel-Chromium-Aluminum (NiCrAl). The metal bonding layer 40 provides oxidation resistance, thermal stability, and enhances adhesion between the core 26 and the heat resistant layer 42. In a specific example, the metal bonding layer 40 has a thickness between about 10-100 microns (μm). In this context, the term “about” will be understood by one of skill in the art. Alternatively, the term “about” will be understood to mean plus or minus 1 μm. In another specific example, the metal bonding layer 40 includes between about 55-65% nickel (Ni), between about 10-30% cobalt (Co), between about 10-20% chromium (Cr), between about 5-10% aluminum (Al), and between about 0.1-0.5% yttrium (Y). In this context, the term “about” will be understood by one of skill in the art. Alternatively, the term “about” will be understood to mean plus or minus 0.5%. In another specific example, the metal bonding layer 40 includes a Nickel-Chromium-Aluminum (NiCrAl) alloy having between about 30-45% chromium (Cr), between about 2-6% aluminum (Al), and the balance being nickel (Ni). In this context, the term “about” will be understood by one of skill in the art. Alternatively, the term “about” will be understood to mean plus or minus 0.5%.

The heat resistant layer 42 is disposed on at least a portion of the metal bonding layer 40 and may include one or more layers (e.g., first and second heat resistant layers). The heat resistant layer 42 includes yttria-stabilized zirconia (YSZ) and ceria-stabilized zirconia (CSZ). Yttria-stabilized zirconia (YSZ) and ceria-stabilized zirconia (CSZ) are advanced ceramic materials used due to their excellent heat resistance and durability. YSZ is used in the heat resistant layer 42 because of its low thermal conductivity. These properties assist in reducing heat transfer to the brake rotor 10, thereby enhancing performance and lifespan of the brake rotor 10. The addition of yttria (Y₂O₃) stabilizes the zirconia in its tetragonal and cubic phases, which are more stable at high temperatures. Ceria (CeO₂) in the CSZ helps stabilize zirconia, similar to yttria, but also provides additional benefits such as improved resistance to sintering and phase transformation at high temperatures.

In a specific example, the heat resistant layer 42 includes about 75% yttria-stabilized zirconia (YSZ) and about 25% ceria-stabilized zirconia (CSZ). In this context, the term “about” will be understood by one of skill in the art. Alternatively, the term “about” will be understood to mean plus or minus 1%. The yttria-stabilized zirconia (YSZ) includes ZrO₂ stabilized with between about 5-10% Y₂O₃. The ceria-stabilized zirconia (CSZ) includes ZrO₂ stabilized with between about 5-10% CeO₂. In a specific example, the heat resistant layer 42 has a thickness between about 50 and 200 micrometers (μm). In this context, the term “about” will be understood by one of skill in the art. Alternatively, the term “about” will be understood to mean plus or minus 5 μm. In another specific example, the heat resistant layer 42 has a thermal conductivity between about 0.4 to 1.5 watts per meter-kelvin (W/m·K). In this context, the term “about” will be understood by one of skill in the art. Alternatively, the term “about” will be understood to mean plus or minus 0.01 W/m·K.

The wear resistant layer 44 is disposed on at least a portion of the heat resistant layer 42 and may include one or more layers (e.g., first and second wear resistant layers). The wear resistant layer 44 serves to improve wear resistance, durability, and overall performance of the brake rotor 10. The wear resistant layer 44 includes stainless steel and carbide feedstock. Stainless steel is used for its excellent corrosion resistance and durability and provides a protective layer that helps prevent rust. Carbide feedstock is used to reinforce the stainless steel and may be incorporated into a matrix of the stainless steel.

In a specific example, the wear resistant layer 44 has a thickness between about 100 and 300 micrometers (μm). In this context, the term “about” will be understood by one of skill in the art. Alternatively, the term “about” will be understood to mean plus or minus 10 μm. The stainless steel may include at least one of 430L steel, 316L steel, 318LN steel, or other suitable stainless steel. The carbide feedstock includes at least one of silicon carbide (SiC), chromium carbide (Cr₃C₂), tungsten carbide (WC), titanium carbide (TiC), or niobium carbide (NbC). Tungsten carbide (WC) provides high hardness and wear resistance. Titanium carbide (TiC) provides wear resistance and may be less prone to forming a brittle phase when compared to silicon carbide (SiC),. Niobium carbide (NbC) provides excellent wear resistance and improved metallurgical compatibility with stainless steel. In a specific example, the wear resistant layer 44 has a thermal conductivity of between about 18 to 50 watts per meter-kelvin (W/m·K). In this context, the term “about” will be understood by one of skill in the art. Alternatively, the term “about” will be understood to mean plus or minus 1 W/m·K. In a specific example, the wear resistant layer 44 has a Vickers hardness number (HV) between about 400-700 HV. In this context, the term “about” will be understood by one of skill in the art. Alternatively, the term “about” will be understood to mean plus or minus 5 HV.

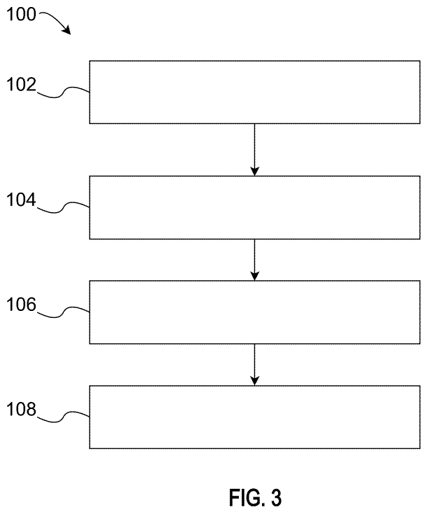

With reference to FIG. 3, a method 100 for manufacturing the brake rotor 10 shown in FIGS. 1 and 2 is presented, in accordance with the present disclosure. The method starts at block 102.

Block 102 depicts casting an Al—Si alloy into a shape of a rotor core 26 (or brake rotor 10) including at least one annular disc 32, 34 having an annular surface 38. Casting the Al—Si alloy may include, for example, determining a composition of the Al—Si alloy and/or creating a mold cavity reflecting a desired mold geometry. Additionally, casting the Al—Si alloy may include using die-casting, sand casting, or a permanent mold casting process. The method 100 then moves to block 104.

Block 104 depicts identifying a thickness-dependent heat and temperature distribution for the annular surface 38. Identifying the thickness-dependent heat and temperature distribution may include conducting a computer simulation using a computer system to identify a mixing rule of coating. Using a mixing rule of coating ensures that each component in the multi-component coating system and/or the multilayer coating 11 is be mixed in a proper ratio for achieving the desired characteristics to ensure that chemical reactions occur correctly. Method 100 then moves to block 106.

Block 106 depicts determining a multilayer coating 11 for the annular surface 38 of the brake rotor 10 based on the thickness-dependent heat and temperature distribution. Determining the multilayer coating may include using a computer system to execute a simulation of the brake rotor 10. As described above, the multilayer coating 11 includes the metal bonding layer 40 disposed on the annular surface 38, the heat resistant layer 42 disposed on the metal bonding layer 40, and the wear resistant layer 44 disposed on the heat resistant layer 42. Method 100 then moves to block 108.

Block 108 depicts depositing the multilayer coating on the annular surface of the brake rotor using a directed energy deposition (DED) process. In some instances, the metal bonding layer 40, the heat resistant layer 42, and the wear resistant layer 44 may be respectively and sequentially deposited on the annular surfaces 38 of the core 26 using directed energy deposition processes. During the directed energy deposition processes, a feedstock material 146 is deposited by a nozzle 148 on the annular surface 38 of the core 26 and simultaneously melted by application of a focused energy source 150 thereto. The nozzle 148 and focused energy source 150 are advanced along the annular surface 38 of the core 26 in a predefined pattern, leaving behind a layer of solidified feedstock material 152. The focused energy source may be a plasma arc, electron beam, or laser. A shielding gas may be applied to a zone 154 surrounding the deposition site to prevent or inhibit undesired side reactions. The feedstock material may be in the form of a wire or a powder and may exhibit substantially the same composition as the layer being formed. For example, during formation of the first and/or second metal bonding layers 40, the feedstock material 146 may have substantially the same composition as that of the metal bonding layer 40 material. During formation of the first and second heat resistant layers 42, the feedstock material 146 may have substantially the same composition as that of the YSZ and CSZ materials. Likewise, during formation of the first and second wear resistant layers 44, the feedstock material 146 may have substantially the same composition as that of the stainless steel and carbide feedstock.

The brake rotor 10 and method 100 of the present disclosure is advantageous and beneficial over prior art. The brake rotor 10 provides a reduced weight brake rotor (about a ⅔ mass reduction) by replacing conventional grey cast iron with lighter material, for example Al—Si. This also increases allowable operating temperatures by about 100° C.-150° C. For example, a typical surface temperature of a grey cast iron rotor during use may be about 478° C. and a typical core temperature during use may be about 432° C. However, when a brake rotor formed of an Al—Si core with a multilayer coating disposed thereon is used, an operating temperature of the core may be about 285° C. when a surface temperature is about 552° C. Additionally, the Al—Si alloy surface has an increased wear resistance because of the wear resistant layer 44, and the brake rotor 10 has a greater oxidation resistance when compared with grey cast iron. Moreover, the wear resistant layer (i.e., a mixture of stainless steel and carbides) matches current brake pad materials and allows for quick technological implementation.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A brake rotor having a multifunctional coating, comprising:
an annular body defining opposite friction surfaces, the annular body including
a core formed of an aluminum-silicon (Al—Si) alloy and including at least one annular disc having an annular surface; and
a multilayer coating disposed on at least a portion of the core, wherein the multilayer coating is configured to provide wear resistance and increase operating temperature, and wherein the multilayer coating includes
a metal bonding layer disposed on the annular surface, wherein the metal bonding layer includes at least one of Nickel-Cobalt-Chromium-Aluminum-Yttrium (NiCoCrAlY) or Nickel-Chromium-Aluminum (NiCrAl);
a heat resistant layer disposed on the metal bonding layer, wherein the heat resistant layer includes yttria-stabilized zirconia (YSZ) and ceria-stabilized zirconia (CSZ); and
a wear resistant layer disposed on the heat resistant layer, wherein the wear resistant layer includes stainless steel and carbide feedstock.

2. The brake rotor of claim 1, wherein the metal bonding layer has a thickness between about 10-100 microns (μm).

3. The brake rotor of claim 1, wherein the metal bonding layer includes between about 55-65% nickel (Ni), between about 10-30% cobalt (Co), between about 10-20% chromium (Cr), between about 5-10% aluminum (Al), and between about 0.1-0.5% yttrium (Y).

4. The brake rotor of claim 1, wherein the metal bonding layer includes a Nickel-Chromium-Aluminum (NiCrAl) alloy having between about 30-45% chromium (Cr), between about 2-6% aluminum (Al), and a balance being nickel (Ni).

5. The brake rotor of claim 1, wherein the heat resistant layer includes about 75% yttria-stabilized zirconia (YSZ) and about 25% ceria-stabilized zirconia (CSZ).

6. The brake rotor of claim 5, wherein the yttria-stabilized zirconia (YSZ) includes ZrO₂ stabilized with between about 5-10% Y₂O₃.

7. The brake rotor of claim 5, wherein the ceria-stabilized zirconia (CSZ) includes ZrO₂ stabilized with between about 5-10% CeO₂.

8. The brake rotor of claim 1, wherein the heat resistant layer has a thickness between about 50 and 200 micrometers (μm).

9. The brake rotor of claim 1, wherein the heat resistant layer has a thermal conductivity between about 0.4 to 1.5 watts per meter-kelvin (W/m·K).

10. The brake rotor of claim 1, wherein the wear resistant layer has a thickness between about 100 and 300 micrometers (μm).

11. The brake rotor of claim 1, wherein the stainless steel includes at least one of 430L steel, 316L steel, or 318LN steel.

12. The brake rotor of claim 1, wherein the carbide feedstock includes at least one of tungsten carbide (WC), titanium carbide (TiC), chromium carbide (Cr3C2), or niobium carbide (NbC).

13. The brake rotor of claim 1, wherein the wear resistant layer has a thermal conductivity of between about 18 to 50 watts per meter-kelvin (W/m·K).

14. The brake rotor of claim 1, wherein the wear resistant layer has a Vickers hardness number between about 400-700 (HV).

15. A brake rotor having a multifunctional coating, comprising:
an annular body defining first and second friction surfaces, the annular body including
a core formed of an aluminum-silicon (Al—Si) alloy and including a first and second annular disc spaced apart from each other in an axial direction by a plurality of ribs, each of the first and second annular discs respectively having a first and second annular surface; and
a first and second multilayer coating disposed respectively on the first and second annular surface, wherein the first and second multilayer coatings are configured to provide wear resistance and increase operating temperature, and wherein the first and second multilayer coatings include
first and second metal bonding layers respectively disposed on the first and second annular surfaces, wherein the first and second metal bonding layers include at least one of Nickel-Cobalt-Chromium-Aluminum-Yttrium (NiCoCrAlY) or Nickel-Chromium-Aluminum (NiCrAl);
first and second heat resistant layers respectively disposed on the first and second metal bonding layers, wherein the first and second heat resistant layers include yttria-stabilized zirconia (YSZ) and ceria-stabilized zirconia (CSZ); and
first and second wear resistant layers respectively disposed on the first and second heat resistant layers, wherein the first and second wear resistant layers include stainless steel and carbide feedstock, wherein the first and second wear resistant layers respectively define the first and second friction surfaces of the annular body.

16. The brake rotor of claim 15, wherein the first and second metal bonding layers include at least one of Nickel-Cobalt-Chromium-Aluminum-Yttrium (NiCoCrAlY) or Nickel-Chromium-Aluminum (NiCrAl).

17. The brake rotor of claim 15, wherein the first and second heat resistant layers include yttria-stabilized zirconia (YSZ) and ceria-stabilized zirconia (CSZ).

18. The brake rotor of claim 15, wherein the first and second wear resistant layers include stainless steel and carbide feedstock.

19. A method for manufacturing a brake rotor, comprising:
casting an Al—Si alloy into a shape of a rotor core including at least one annular disc having an annular surface;
identifying a thickness-dependent heat and temperature distribution for the annular surface;
determining a multilayer coating for the annular surface of the brake rotor based on the thickness-dependent heat and temperature distribution, wherein the multilayer coating includes:
a metal bonding layer disposed on the annular surface;
a heat resistant layer disposed on the metal bonding layer; and
a wear resistant layer disposed on the heat resistant layer; and
depositing the multilayer coating on the annular surface of the brake rotor using a directed energy deposition (DED) process to form a wear-resistant layer.

20. The method of claim 19, wherein the metal bonding layer includes at least one of Nickel-Cobalt-Chromium-Aluminum-Yttrium (NiCoCrAlY) or Nickel-Chromium-Aluminum (NiCrAl), wherein the heat resistant layer includes yttria-stabilized zirconia (YSZ) and ceria-stabilized zirconia (CSZ), and wherein the wear resistant layer includes stainless steel and carbide feedstock.
